(19) United States
(12) Patent Application Publication
(10) Pub. No.: US 2004/0177344 A1
(43) Pub. Date: Sep. 9, 2004

(54) Debugging method for the keyboard controller code

(76) Inventor: Jia-Shiung Kuo, Taipei (TW)

Correspondence Address: BIRCH STEWART KOLASCH & BIRCH, PO BOX 747, FALLS CHURCH, VA, 22040-0747, US

(21) Appl. No.: 10/378,941

(22) Filed: Mar. 5, 2003

(51) Int. Cl. G06F 9/44

(52) U.S. Cl. 717/125; 717/134; 717/135

(57) ABSTRACT

A debugging method is used for the keyboard controller code. Through the breakpoints set at the testing end and loaded debugging program, the keyboard controller code sends state data to the testing end at the breakpoints in accord with the debugging program. The testing end returns commands according to the received state data to trace the execution state of the code, thereby debugging the code procedure.

### BACKGROUND OF THE INVENTION

1. Field of Invention

The invention relates to a code debugging method and, in particular, to a debugging method for the keyboard controller code.

2. Related Art

In the development of the keyboard controller code, most debugging methods ask for a parameter in an embedding control code and then test specific parts according to the experience. The value or variable obtained after the code finishes its operation is used to diagnose the logic of the code. This helps determine whether the code is running according to the designer's idea and, moreover, allows the embedding control code to have the desire functions. However, such a debugging method often depends upon the tester's experience. Once the code becomes too large, the tester has to spend a lot of time in a tremendously long calculation procedure. Therefore, they are not efficient and practical.

### SUMMARY OF THE INVENTION

In view of the foregoing, the invention provides a debugging method for the keyboard controller code. Its operation principle is to have the tested end download a debugging program, according to which the tested end sends out its state data in exchange of commands returned from the testing end for debugging. A primary objective is to enable the programmer to clearly understand the detailed actions of the code from the execution state data sent from the tested end.

The disclosed method contains the steps of: loading a debugging program from a testing end to a tested end; setting a plurality of breakpoints in the tested keyboard controller code by the testing end; executing the keyboard controller code until it reaches a breakpoint; the tested end's outputting initial state data to the testing end and waiting the testing end for a command; the testing end's sending a command to the tested end according to the initial state data; determining whether the command is a quit; the tested end's executing the command and displaying a program state for debugging; the testing end's quitting the state data receiving mode; and determining whether to continue receiving the command.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of the disclosed debugging method for the keyboard controller code.

### DETAILED DESCRIPTION OF THE INVENTION

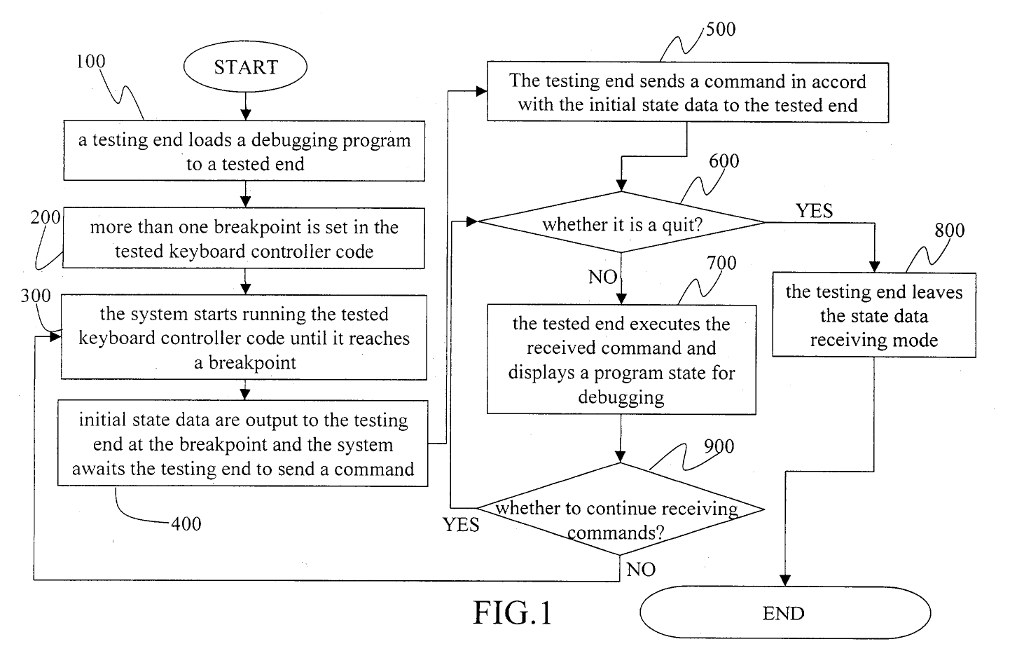

We use an embodiment to demonstrate the feasibility of the invention. Please refer to FIG. 1. First, a testing end loads a debugging program to a tested end (step 100). The debugging program can send data to the testing end and receives command from the testing end. More than one breakpoint is set in the tested keyboard controller code (step 200). The system then starts running the tested keyboard controller code until it reaches a breakpoint (step 300). According to the debugging program, initial state data are output to the testing end at the breakpoint and the system awaits the testing end to send a command (step 400). The testing end sends a command in accord with the initial state data to the tested end (step 500). At the same time of setting the command, the testing end also determines the syntax of the command, determining whether it is a quit (step 600). If it is a quit, the testing end leaves the state data receiving mode (step 800), finishing the debugging procedure. If it is not a quit, the tested end executes the received command and displays a program state for debugging (step 700). After the execution of the command is over, the system determines whether to continue receiving commands (step 900). If so, then the system determines whether it is a quit (step 600). If it is not a quit, then the tested end continues running the program from the breakpoint (step 300).

Effects of the Invention

The debugging method for the keyboard controller code enables the tester to find every possible error as the testing end provides state data. It replaces the old lengthy debugging procedure.

Certain variations would be apparent to those skilled in the art, which variations are considered within the spirit and scope of the claimed invention.

What is claimed is:

1. A debugging method for the keyboard controller code for a testing end to debug the keyboard controller code on a tested end, the method comprising the steps of:
the testing end's loading a debugging program to a tested end;
the testing end's setting a plurality of breakpoints in the tested keyboard controller code;
executing the keyboard controller code on the tested end until it reaches a breakpoint;
the tested end's outputting initial state data to the testing end and waiting the testing end for a command;
the testing end's sending a command to the tested end according to the initial state data; and
the tested end's executing the command and displaying a program state for debugging.

2. The method of claim 1, wherein the testing end is in electrical communications with the tested end via a parallel port.

3. The method of claim 1 further comprising the steps of the tested end's stopping running the program and the testing end's leaving the state data receiving mode if the command from the testing end is a quit.

4. The method of claim 1, wherein the step of the tested end's executing the command for debugging includes the step of dumping memory data.

5. The method of claim 1, wherein the step of the tested end's executing the command for debugging includes the step of dumping code space data.

6. The method of claim 1, wherein the step of the tested end's executing the command for debugging includes the step of entering data in memory.

7. The method of claim 1, wherein the step of the tested end's executing the command for debugging includes a go and a quit.

8. The method of claim 1, wherein the step of the tested end's executing the command for debugging includes step or trace.

9. The method of claim 1, wherein the debugging program is stored in RAM on the tested end.

10. The method of claim 1, wherein the program states include the program state resulting from executing the command.
